(19) United States
(12) Patent Application Publication
(10) Pub. No.: US 2026/0135859 A1
(43) Pub. Date: May 14, 2026

(54) TOTAL SOLUTION PROVIDING SYSTEM FOR SUPRESSING GENERATION OF, DETECTING AND PREVENTING DISTRIBUTION OF DEEPFAKE

(71) Applicants: Seong Choi, Seoul (KR); Jee Woo Yoon, Seoul (KR); Dae Hwan Park, Seoul (KR); Ki Woong Kim, Anyang-si (KR); Deog Hyeon Ga, Seoul (KR); Raondata Co., Ltd., Seoul (KR)

(72) Inventors: Seong CHOI, Seoul (KR); Jee Woo Yoon, Seoul (KR); Dae Hwan Park, Seoul (KR); Ki Woong Kim, Anyang-si (KR); Deog Hyeon Ga, Seoul (KR)

(73) Assignees: Seong Choi, Seoul (KR); Jee Woo Yoon, Seoul (KR); Dae Hwan Park, Seoul (KR); Ki Woong Kim, Anyang-si (KR); Deog Hyeon Ga, Seoul (KR); Raondata Co., Ltd., Seoul (KR)

(21) Appl. No.: 19/273,294

(22) Filed: Jul. 18, 2025

(30) Foreign Application Priority Data
Nov. 12, 2024 (KR) 10-2024-0160019

(51) Int. Cl. H04L 9/40; G06V 10/764; G06V 10/774; G06V 10/82; G06V 20/00; G10L 17/04; G10L 17/18; G10L 17/26

(52) U.S. Cl. CPC H04L 63/126; G06V 10/764; G06V 10/774; G06V 10/82; G06V 20/95; G10L 17/04; G10L 17/18; G10L 17/26

(57) ABSTRACT

A total solution providing system for suppressing generation of, detecting, and preventing distribution of a deepfake is provided, and includes a user terminal that selects any one of functions of suppressing generation of, detecting, and preventing distribution of a deepfake, and requests performance of the selected function; and a total solution providing server including a construction unit that constructs an artificial intelligence (AI) model for suppressing generation of, detecting, and preventing distribution of the deepfake, a loading unit that loads an AI model corresponding to the function selected through the user terminal, a driving unit that allows the user terminal to use the AI model, and a providing unit that provides a driving result of the AI model to the user terminal.

### GOVERNMENT FUNDING

This invention was made with support from the following R&D projects funded by the Ministry of Science and ICT (MSIT), Republic of Korea:

Project No. RS-2023-00230337 (Project Unique ID: 2710008048), titled “Development of a Platform for Advanced Deepfake Detection, Generation Suppression, and Distribution Prevention of Maliciously Manipulated Content,” supported by the R&D Program for Responding to Digital Malfunctions and managed by the Institute of Information & Communications Technology Planning & Evaluation (IITP). The project is being carried out from Apr. 1, 2023 to Dec. 31, 2025, with the participation of Sungkyunkwan University Research & Business Foundation, Yonsei University Research Foundation, Soongsil University Research Foundation, and RAONDATA.

Project No. RS-2024-00436936 (Project Unique ID: 2710008857), titled “Deepfake Research Center,” supported by the R&D Program for ICT and Broadcasting Talent Development and managed by the Institute of Information & Communications Technology Planning & Evaluation (IITP). The project is being carried out from Jul. 1, 2024 to Dec. 31, 2031, with the participation of Sungkyunkwan University Research & Business Foundation, Electronics and Telecommunications Research Institute (ETRI), Ulsan National Institute of Science and Technology (UNIST), Yonsei University Research Foundation, Allbigdat Co., Ltd., and RAONDATA.

### CROSS-REFERENCE TO RELATED APPLICATION

This application claims the benefit of and priority to Korean Patent Application No. 10-2024-0160019, filed on Nov. 12, 2024, the disclosure of which is hereby incorporated by reference in its entirety.

### TECHNICAL FIELD

The present invention relates to a total solution providing system for suppressing generation of, detecting, and preventing distribution of a deepfake, and provides a total solution that constructs an artificial intelligence (AI) model for suppressing generation of, detecting, and preventing distribution of a deepfake, and provides an infrastructure as a cluster that allows the AI model as a cluster to be driven.

### BACKGROUND ART

Deepfake technology is rapidly developing and causing serious social problems in Korea. As various open-source tools have made it easy for anyone to access the deepfake technology, there has been an increase in cases where teenagers in particular are misusing the deepfake technology. In addition to personal damage, deepfakes are used in political campaigns to slander opposing candidates or spread false information, and crimes such as investment fraud using celebrities are also occurring. “Deepfake” is a compound word of “deep learning” and “fake,” and refers to a technology of generating new images by combining different images with original images using a generative adversarial network (GAN). The GAN generates data similar to the original through competition between a generator, which tries to generate data indistinguishable from the original, and a discriminator, which detects differences from the original.

In this case, a method of discriminating a deepfake image or detecting a voice has been studied and developed. In relation to this, the related art Korean Laid-Open Patent No. 2023-0017650 (published on Feb. 6, 2023) and Korean Laid-Open Patent No. 2024-0135340 (published on Sep. 10, 2024) disclose a configuration for obtaining a target image, extracting features using pixel-level noise information included in the target image, and then discriminating whether the target image has been manipulated based on the features, and a configuration for filtering voice data with a bandpass filter, mixing noise generated by an adversarial attack technique to generate a training dataset, and modeling a deep learning model for detecting deep voice, respectively.

However, in the former case, a detection rate decreases when the image is compressed or a resolution is low, and in the latter case, the deep voice that is not mixed with noise is not detected. Recently, many technologies have been released to detect deepfake content. However, these technologies are only focused on detecting a deepfake, and thus have limitations when it comes to malicious content that has already been distributed. Accordingly, research and development of active response methods that may suppress generation of a deepfake or prevent distribution of a deepfake is required.

### DESCRIPTION OF INVENTION

### Technical Problem

An embodiment of the present invention provides a total solution providing system for suppressing generation of, detecting, and preventing distribution of a deepfake that constructs an artificial intelligence (AI) model for suppressing generation of, detecting, and preventing distribution of the deepfake, when a desired function is selected through a user terminal, allows the AI model corresponding to the selected function to be used, constructs a cluster including nodes and graphics processing units (GPUs) that allows the AI model to be driven, performs functions without interruption even when some failures occur by operating one or more containers in parallel in the cluster so that the function selected through the user terminal is performed, sets the cluster to flexibly increase the number of nodes and GPUs according to the type and scale of the AI model, and applies a GPU acceleration technology to improve training and inference performance of the AI model. However, the technical problems to be achieved by the present embodiments are not limited to the technical problems as described above, and other technical problems may exist.

### Technical Solution

As a technical means for achieving the above-described technical task, an embodiment of the present invention includes a user terminal that selects any one of functions of suppressing generation of, detecting, and preventing distribution of a deepfake, and requests performance of the selected function; and a total solution providing server including a construction unit that constructs an artificial intelligence (AI) model for suppressing generation of, detecting, and preventing distribution of the deepfake, a loading unit that loads an AI model corresponding to the function selected through the user terminal, a driving unit that allows the user terminal to use the AI model, and a providing unit that provides a driving result of the AI model to the user terminal.

### Advantageous Effects

According to any one of the means for solving the problems of the present invention described above, an artificial intelligence (AI) model can be constructed to suppress generation of, detect, and prevent distribution of a deepfake, when a desired function is selected through a user terminal, the AI model corresponding to the selected function can be used, a cluster including nodes and graphics processing units (GPU) can be constructed to drive the AI model, one or more containers can operate in parallel in the cluster to perform the function selected through the user terminal, thereby performing the function without interruption even when some failures occur, the cluster can be set to flexibly increase the number of nodes and GPUs according to the type and scale of the AI model, and a GPU acceleration technology can be applied to improve training and inference performance of the AI model.

### DESCRIPTION OF DRAWINGS

FIG. 1 is a diagram for describing a total solution providing system for suppressing generation of, detecting, and preventing distribution of a deepfake according to an embodiment of the present invention.

FIG. 2 is a block configuration diagram for describing a total solution providing server included in the system of FIG. 1.

FIGS. 3a-3b and 4a-4h are diagrams for describing an example in which a total solution for suppressing generation of, detecting, and preventing distribution of a deepfake is implemented according to an embodiment of the present invention.

FIG. 5 is an operation flowchart for describing a total solution providing method of suppressing generation of, detecting, and preventing distribution of a deepfake according to an embodiment of the present invention.

### MODES OF THE INVENTION

Hereinafter, embodiments of the present invention will be described in detail with reference to the accompanying drawings so that those skilled in the art to which the present invention pertains may easily practice the present invention. However, the present invention may be modified in various different ways and is not limited to the embodiments provided in the present description. In the accompanying drawings, portions unrelated to the description will be omitted in order to obviously describe the present invention, and similar reference numerals will be used to describe similar portions throughout the present specification.

Throughout the present specification, when any one part is referred to as being “connected to” another part, it means that any one part and another part are “directly connected to” each other or are “electrically connected to” each other with still another part interposed therebetween. Also, when a certain part “includes” a certain component, it means that other components may be further included, rather than excluding other components, unless otherwise stated, and it should be understood that it does not preclude the possibility of addition or presence of one or more other features, numbers, steps, operations, elements, parts, or combinations thereof.

The terms “about,” “substantially,” and the like used throughout the present specification mean figures corresponding to manufacturing and material tolerances specific to the stated meaning and figures close thereto, and are used to prevent unconscionable abusers from unfairly using the disclosure of figures precisely or absolutely described to aid the understanding of the present invention. The term “step” or “step of” used throughout the present specification of the present invention does not mean “step for.”

In the present specification, the term “unit” includes a unit implemented by hardware, a unit implemented by software, and a unit implemented by both hardware and software. Further, one unit may be implemented by two or more pieces of hardware, and two or more units may be implemented by one piece of hardware. However, a “unit” is not limited to software or hardware, and may be configured to reside in an addressable storage medium or configured to reproduce one or more processors. Therefore, as an example, a “unit” includes components such as software components, object-oriented software components, class components and task components, processes, functions, attributes, procedures, subroutines, segments of program code, drivers, firmware, microcode, circuits, data, databases, data structures, tables, arrays, and variables. Components and functions provided within a “unit” may be combined into a smaller number of components and “units” or may be further separated into additional components and “units.” In addition, components and “units” may be implemented to play one or more CPUs in a device or a secure multimedia card.

In the present specification, some of the operations or functions described as performed by a terminal, an apparatus, or a device may be performed instead in a server connected to the corresponding terminal, apparatus, or device. Similarly, some of the operations or functions described as being performed by a server may be performed in a terminal, an apparatus, or a device connected to the corresponding server.

In the present specification, some operations or functions described as mapping with or matching a terminal are meant to map or match with a unique number of the terminal or personal identification information, which is identification data of the terminal.

Hereinafter, the present invention will be described in detail with reference to the accompanying drawings.

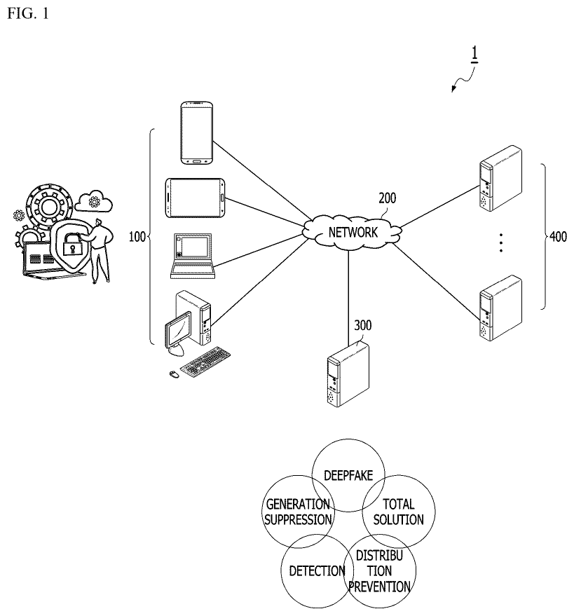

FIG. 1 is a diagram for describing a total solution providing system for suppressing generation of, detecting, and preventing distribution of a deepfake according to an embodiment of the present invention. Referring to FIG. 1, the total solution providing system 1 for suppressing generation of, detecting, and preventing distribution of a deepfake may include at least one user terminal 100, a total solution providing server 300, and at least one information providing server 400. However, since the total solution providing system 1 for suppressing generation of, detecting, and preventing distribution of a deepfake of FIG. 1 is merely an embodiment of the present invention, interpretation of the present invention is not limited by FIG. 1.

In this case, each component of FIG. 1 is generally connected through a network 200. For example, as illustrated in FIG. 1, at least one user terminal 100 may be connected to the total solution providing server 300 through a network 200. The total solution providing server 300 may be connected to at least one user terminal 100 and at least one information providing server 400 through the network 200. In addition, at least one information providing server 400 may be connected to the total solution providing server 300 through the network 200.

Here, the network is a connection structure in which information exchange is possible between respective nodes, such as a plurality of terminals and servers, and examples of such a network include a local area network (LAN), a wide area network (WAN), the Internet (World Wide Web (WWW)), wired and wireless data communication networks, telephone networks, wired and wireless television networks, and the like. Examples of the wireless data communication network include 3G, 4G, 5G, 3rd Generation Partnership Project (3GPP), 5th Generation Partnership Project (5GPP), 5G new radio (5G NR), 6th generation (6G) of cellular networks, Long Term Evolution (LTE), World Interoperability for Microwave Access (WiMAX), Wi-Fi, the Internet, a LAN, a WLAN, a wide area network (WAN), a personal area network (PAN), radio frequency, a Bluetooth network, a near-field communication (NFC) network, a satellite broadcast network, an analog broadcast network, a digital multimedia broadcasting (DMB) network, and the like, but are not limited thereto.

In the following, the term “at least one” is defined as including the singular and plural, and even when the term “at least one” is not present, each component may be present in singular or plural, and it will be obvious that it may mean singular or plural. In addition, whether each component is provided in singular or plural can be changed according to embodiments.

At least one user terminal 100 may be a terminal of a user who selects one of the functions of suppressing generation of, detecting, and preventing distribution of a deepfake using a web page, an app page, a program, or an application related to a total solution for suppressing generation of, detecting, and preventing distribution of a deepfake, and uses the selected function.

Here, the at least one user terminal 100 may be implemented as a computer capable of accessing a server or a terminal at a remote location through a network. Here, the computer may include, for example, navigation, a notebook equipped with a web browser, a desktop, a laptop, and the like. In this case, the at least one user terminal 100 may be implemented as a terminal capable of accessing a server or a terminal at a remote location through a network. The at least one user terminal 100 is a mobile communication device in which portability and mobility are guaranteed, and examples thereof may include all types of handheld-based wireless communication devices such as a personal communication system (PCS), global system for mobile communication (GSM), personal digital cellular (PDC), a personal handyphone system (PHS), a personal digital assistant (PDA), international mobile telecommunication (IMT)-2000, code division multiple access (CDMA)-2000, W-code division multiple access (W-CDMA), a wireless broadband Internet (WiBro) terminal, a smartphone, a smart pad, a tablet PC, and the like.

The total solution providing server 300 may be a server that provides a total solution web page, an app page, a program, or an application for suppressing generation of, detecting, and preventing distribution of a deepfake. The total solution providing server 300 may be a server that constructs an AI model for suppressing generation of, detecting, and preventing distribution of a deepfake and constructs an infrastructure for driving the AI model as a cluster including a physical server and a graphics processing unit (GPU). In addition, the total solution providing server 300 may be a server that drives the AI model corresponding to the function requested by the user terminal 100 in at least one container within the cluster.

Here, the total solution providing server 300 may be implemented as a computer capable of accessing a remote server or terminal through a network. Here, the computer may include, for example, a navigation system, a notebook, a laptop, a desktop equipped with a web browser, etc.

At least one information providing server 400 may be a server that provides a dataset for constructing an AI model for suppressing generation of, detecting, and preventing distribution of a deepfake using a web page, an app page, a program, or an application related to a total solution for suppressing generation of, detecting, and preventing distribution of a deepfake, or may be a server that provides data to be detected while the AI model is driving. Here, at least one information providing server 400 may be implemented as a computer capable of accessing a server or a terminal at a remote location through a network. Here, the computer may include, for example, a navigation system, a notebook, a laptop, and a desktop equipped with a web browser, etc.

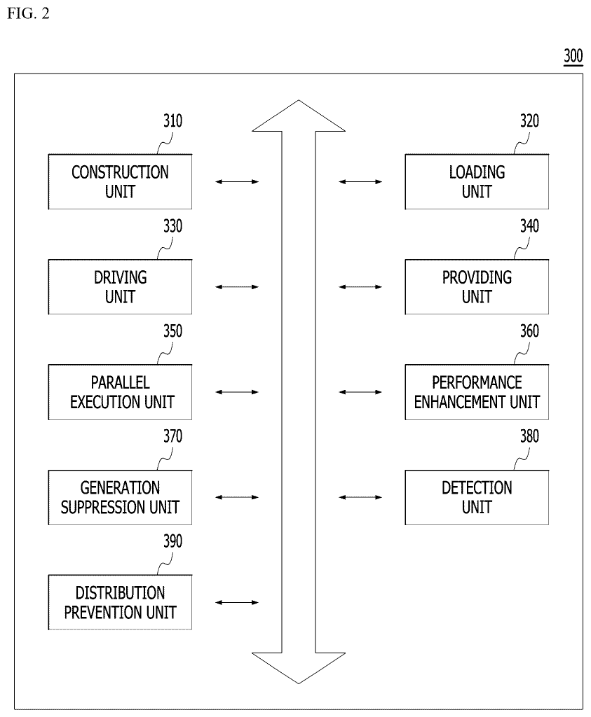

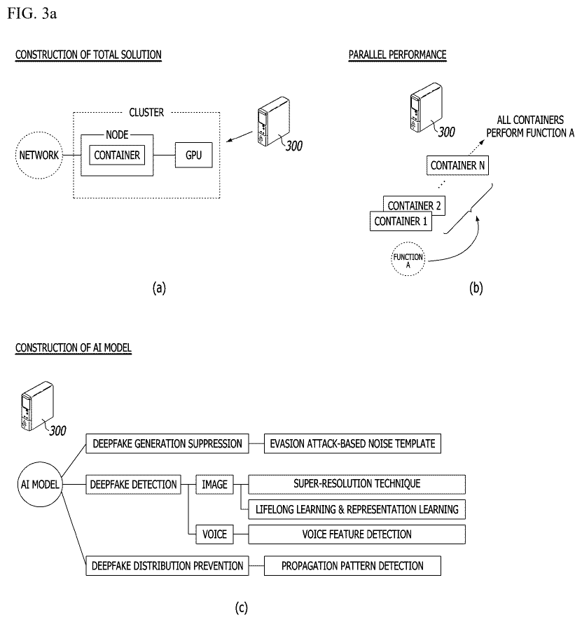

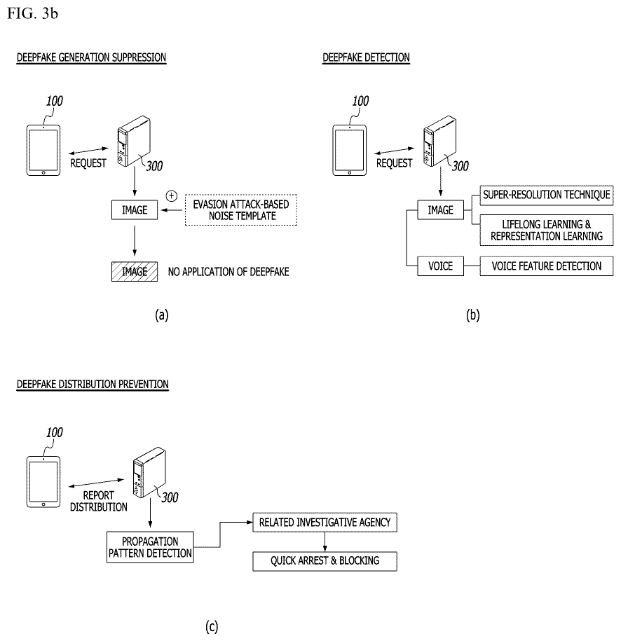

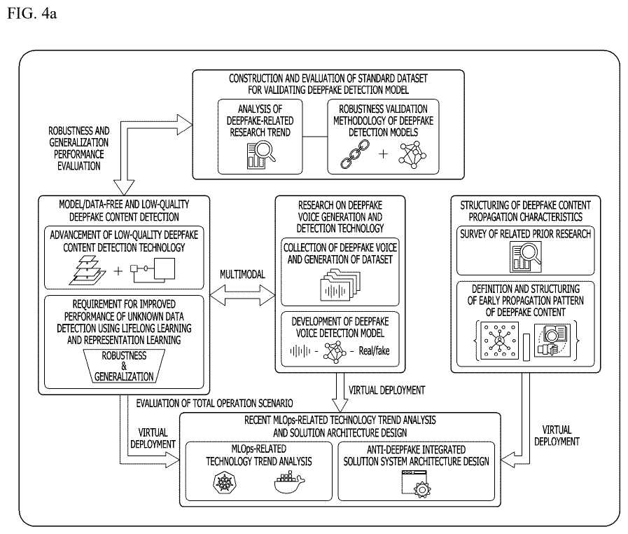

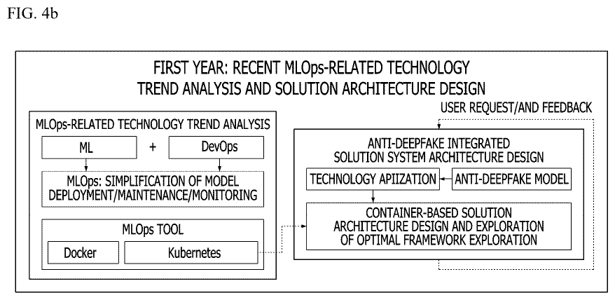

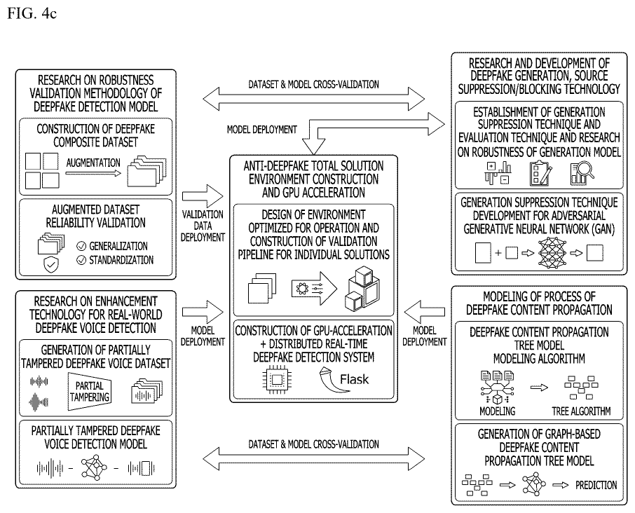

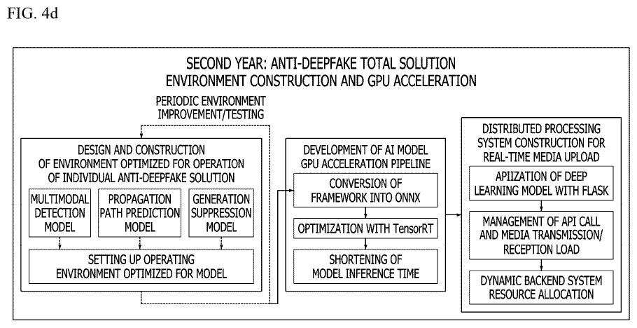

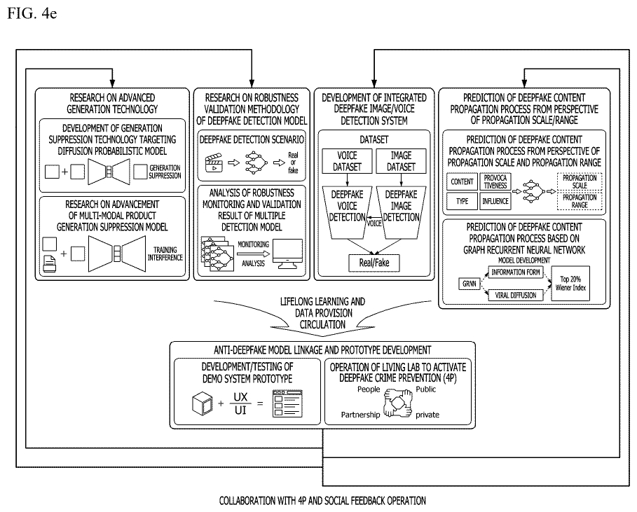

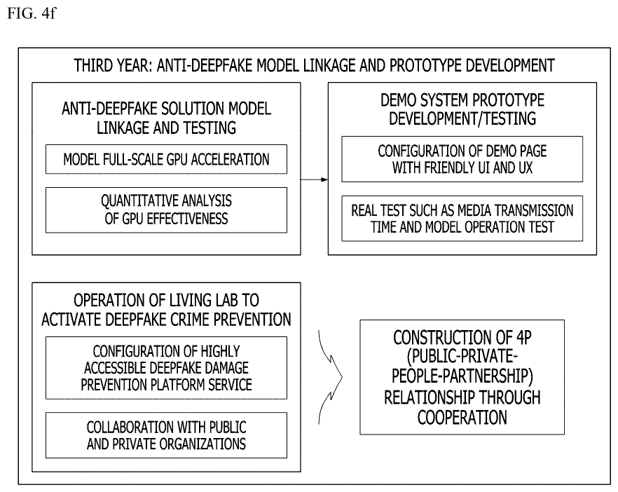

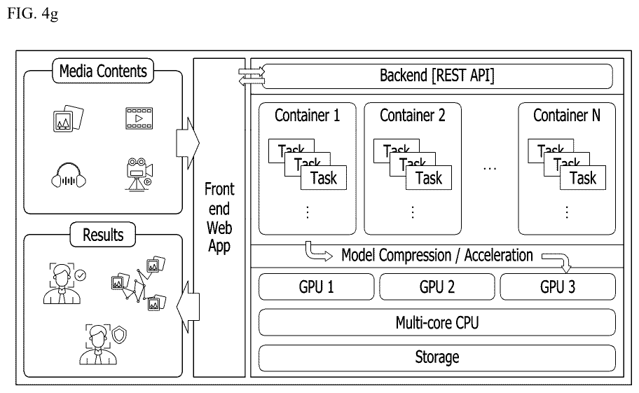

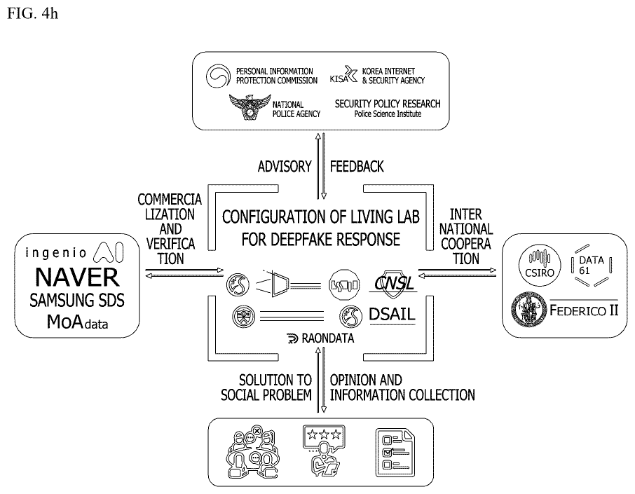

FIG. 2 is a block diagram for describing a total solution providing server included in the system of FIG. 1, and FIGS. 3a-3b and 4a-4h are diagrams for explaining an example in which a total solution for suppressing generation of, detecting, and preventing distribution of a deepfake according to an embodiment of the present invention is implemented.

Referring to FIG. 2, the total solution providing server 300 may include a construction unit 310, a loading unit 320, a driving unit 330, a providing unit 340, a parallel execution unit 350, a performance enhancement unit 360, a generation suppression unit 370, a detection unit 380, and a distribution prevention unit 390.

In the case where the total solution providing server 300 according to an embodiment of the present invention, or another server (not illustrated) operating in conjunction with the total solution providing server 300 transmits a total solution application, a program, an app page, a web page, etc., for suppressing generation of, detecting, and preventing distribution of a deepfake to at least one user terminal 100 and at least one information providing server 400, at least one user terminal 100 and at least one information providing server 400 may install or open the total solution application, the program, the app page, the web page, etc., for suppressing generation of, detecting, and preventing distribution of a deepfake. In addition, the service program may be driven on at least one user terminal 100 and at least one information provision server 400 by using a script running on the web browser. Here, the web browser is a program that enables the use of a web (WWW) service, and is a program that receives and displays hypertext written in hyper text mark-up language (HTML), and examples include Chrome, Edge (Microsoft Edge), Safari, Firefox, Whale, UC Browser, etc. In addition, the application is an application on a terminal, and examples include an app executed in a mobile terminal (smartphone).

Referring to FIG. 2, the construction unit 310 may construct the AI model for suppressing generation of, detecting, and preventing distribution of a deepfake. The method of constructing each AI model for suppressing generation of, detecting, and preventing distribution of a deepfake will be described in detail in the following description of the generation suppression unit 370, detection unit 380, and distribution prevention unit 390. In this case, the construction unit 310 may construct the AI model described above on a machine learning operations (MLOps) platform.

### <MLOps>

“MLOps” is a term combining “machine learning (ML)” and “operations (Ops)” and means deploying and maintaining a machine learning model in a production environment in a stable and efficient manner. In general, in order to construct the AI model, a dataset is constructed, preprocessing is performed, an AI model is selected, learning-validation-testing is performed, and a best-performing AI model is selected and set. The process described so far is a process of [ML]. Thereafter, an operation in which a user accesses the user terminal 100 and actually uses the set AI model is an [Ops] process. In other words, this operation is the actual operation process. In general, each of the two processes occurs on separate platforms, but the MLOps optimizes the productivity of development and the stability of operations without separately performing the development (ML) and operations (Ops).

In addition, since, for the AI model that has been developed once, data continues to be generated, and continuous training should be performed on the data, continuous re-training and evolution are possible when the development and operations are provided on a single platform. Automatically and continuously processing this process is the basic concept of the MLOps. Major MLOps currently in service include these element technologies and further provide additional functions. Among the representative MLOps tools, public clouds include Google Vertex AI, MS machine learning Azure, Amazon SageMaker, etc., and Kubeflow is famous as an open source code-based project. This is summarized in Table 1 below. In an embodiment of the present invention, the following MLOps may be used, or the MLOps may be constructed and used independently.

TABLE 1

| | Google Vertex | MS Azure ML | AWS SageMaker | Kubeflow |
|---|---|---|---|---|
| Driving platform | GCP-based Vertex | Azure-based MLOps | AWS-based MLOps | Kubernetes-based |
| | AI platform | platform | platform | open source |
| Data preparation task | Data labeling service | Data labeling service | Ground truth support | Jupyter notebook is |
| | support | support | for data labeling | used |
| | Dataset | | | |
| | management support | | | |
| Neural network | Pipeline execution | Pipeline-based | Pipeline support | Pipeline support |
| model | based on integrated | learning for parallel | | Hyperparameter |
| training/parallel | metadata | processing | | tuning support |
| processing | Support for parallel | | | AutoML |
| | processing | | | |
| Neural network | Custom-based | Custom-based | Custom-based | KFServing |
| model deployment | deployment | deployment | deployment | Pre/post-processing |
| | | | | inference phase |
| | | | | support |
| Parallelization, low | Traffic distribution | GPU and traffic | Traffic distribution | Automatic scaling |
| latency, multi-model | Low latency support | distribution | Multi-model | Traffic distribution |
| support | | processing | support | Multi-model |
| | | | Elastic inference | service |
| | | | support for low | GPU integrated |
| | | | latency | execution |
| Neural network | Latency monitoring | Delay and HW | Custom monitoring | Resource and high- |
| model performance | | resource monitoring | schedule support | level matrix support |
| and monitoring | | | CloudWatch | |
| Neural network | — | Workspace | Neural network | — |
| management | | management support | management support | |
| | | | by version, group, | |
| | | | and institution | |

### <Cloud Service>

In this case, the ML inherently requires a large amount of computing resources because the ML performs a process of training artificial intelligence. The cloud is a computer service structure that is flexibly allocated necessary resources and provides the resources to users and may solve the problem of ML requiring more resources through high-performance computing. In this way, as the amount of user traffic increases, tech companies representing the existing Web 2.0 era are moving away from the existing monolithic structure and transitioning to cloud infrastructure-based micro services architecture (MSA). Accordingly, the importance of an orchestration tool that controls the micro services has increased. Currently, the implementation of application services based on a cloud-native computing-based MSA method is becoming the trend.

Here, Kubernetes (K8s) is a container orchestration tool developed by Google and is a tool that helps companies to operate containerized cluster environments well. In other words, K8s is an open source-based container orchestration tool that makes large-scale deployment, scaling, and management of containerized applications easy. In this case, the orchestration is the management and adjustment of cloud resources such as computing, storage, and networking. Based on this, the total solution of the present invention may be constructed.

### <Total Solution>

The total solution providing server 300 may be composed of a node corresponding to a physical server and at least one GPU connected to the node. The total solution providing server 300 may be configured so that one or more GPUs are connected to two nodes. In addition, the total solution providing server 300 may be generated as a cluster in which nodes are connected to a network and perform functions. In this case, at least one GPU may be connected to one node. One or more GPUs may be connected to one node. Alternatively, the nodes and the GPUs may increase according to the demand of the AI model. In this case, the increase in the number of nodes and GPUs may mean actually connecting additional hardware, or mean that the hardware is already formed and the already formed hardware is allocated through software to fill the computing resource amount required by the AI model.

In the above-described MLOps, a container technology, a cluster technology, and an orchestration technology may be applied for servicing the ML and the Ops. For example, when the user terminal 100 requests a desired ML service from the MLOps platform, the edge cloud performs the ML operation requested by the user and then provides the result to the user. When the ML service requests the operation of a model that does not exist in the edge cloud or a pre-trained model is old and thus requires model update, the data is transmitted to the core cloud and a newly trained model is requested. The core cloud trains the model and deploys the trained model in each edge cloud. Through the model deployed in the edge cloud, the user may receive the result of the ML service requested from the MLOps framework.

The ML service is managed as the container in the assigned edge cloud. For example, when a user requests an image classification model, the edge cloud creates a container that performs image classification and performs an inference process. However, when there is no pre-trained model in a model repository, the image classification model training phase is performed. In the training phase, the image classification model is trained using data collected and stored in the model training container in the core cloud and deployed in the edge cloud. In this case, the container is an isolation technology that covers the environment in which the application is driven, allowing the container to be easily executed anywhere, and a docker is the most famous tool among tools that handle the container. In other words, the docker is a tool that makes it easy to download, share, and drive the container. Kubernetes is a tool that handles the container through the container runtime. What Kubernetes does is distribute and deploy the container in multiple servers, that is, nodes, replace containers with problems, or manage and input passwords and settings that the containers will use. This is called container orchestration.

The differences between the virtual machine-based deployment and the container-based deployment are as illustrated in Table 2 below.

TABLE 2

| | | Virtual machine-based | Container-based |
|---|---|---|---|
| | Traditional deployment | deployment | deployment |
| Computer | One physical computer | Plurality of virtual | Not affected by computer |
| | | machines exist on one | type |
| | | physical computer | |
| OS | One OS is installed on one | One physical computer | One OS installed |
| | physical computer | OS + OS installed on each | regardless of computer |
| | | of plurality of virtual | type |
| | | machines | |
| Resources | Sharing resources of one | Individual resource | OS allocates and manages |
| | computer among multiple | allocation for each virtual | resources for each |
| | programs | machine through | program |
| | | hypervisor | |
| Isolation | Interference between | Each virtual machine is | Program execution |
| level | programs occurs due to | completely isolated | environment is isolated, |
| | failure of isolation | | but OS environment is |
| | | | shared |
| Possibility | Problem with specific | Problem with specific | Problem with specific |
| of problem | program can cause a | virtual machine is unlikely | program does not interfere |
| transfer | system-wide shutdown | to be transferred to | with other programs, but |
| | | another virtual machine | when problem with |
| | | | specific program causes |
| | | | OS problem, there is a |
| | | | possibility of system |
| | | | shutdown |

The loading unit 320 may load the AI model corresponding to the function selected through the user terminal 100. The user terminal 100 may select any one of the functions of suppressing generation of, detecting, and preventing distribution of a deepfake. When the user wants to prevent the photo he or she uploads to Facebook from being generated as a deepfake, he or she may select [deepfake generation suppression], and the loading unit 320 may load an AI model corresponding thereto. In addition, when the user terminal 100 is curious about whether his or her face is being synthesized into a deepfake and spread, the user terminal 100 may select [deepfake detection], and the loading unit 320 may load an AI model corresponding thereto. In addition, when the user terminal 100 identifies that his or her photo has been distributed, the user terminal 100 may select [deepfake distribution prevention] to identify how far his or her photo is currently spread and predict where his or her photo will spread, and prevent his or her photo from spreading further, and the loading unit 320 may load an AI model corresponding thereto.

The driving unit 330 may enable the user terminal 100 to use the AI model. The user terminal 100 may request the execution of the selected function. Using this function, the user may prevent his or her photo from being synthesized into a deepfake and distributed, check whether his or her photo is being synthesized into a deepfake and spread, and when his or her photo has started to spread, determine where it will spread in the future and prevent the photo from spreading further.

The providing unit 340 may provide the driving result of the AI model to the user terminal 100. When the function of the AI model selected by the user terminal 100 was [deepfake detection], and a photo synthesized into a deepfake was actually detected, the user terminal 100 confirmed that the photo was a deepfake photo. By adding a watermark to the photo, others can recognize that the photo is a deepfake and be guided to neither distribute nor download the deepfake photo. Of course, even when the victim himself/herself does not confirm, when it is actually determined to be deepfake content, the platform of the present invention may process the watermark independently. As the deepfake sexual crime prevention Act passed the National Assembly, not only distributing deepfake sexual crime materials, but also possessing, purchasing, storing, or viewing deepfake sexual crime materials is subject to imprisonment of up to 3 years or a fine of up to 30 million won. In addition, since even viewing is punishable, watermarks may be placed on photos to prevent viewing, and instructions may be provided on videos to be watched to prevent the innocent from becoming victims.

The parallel execution unit 350 may be configured to execute the function of a cluster as a plurality of containers when performing the function of suppressing generation of, detecting, and preventing distribution of a deepfake, and may be operated so that, even when a failure occurs in one of the plurality of containers, another container may perform the function instead. In other words, the parallel execution unit 350 may be configured so that a seamless service is provided by having the plurality of containers perform function A simultaneously.

The performance enhancement unit 360 may apply AI model acceleration and lightweight technology to enhance the training and inference performance of the AI model. In this case, the AI model acceleration technology is GPU acceleration technology. This is because it is essential to optimize and accelerate GPU operations in order to serve the AI model that operates in a GPU environment. To this end, as illustrated in FIG. 4D, the most commonly used deep learning frameworks, Tensorflow or Pytorch, may be converted into open neural network exchange (ONNX) to support a cross platform, and then optimized with TensorRT to shorten the inference time of the AI model in the GPU environment. In addition, by constructing an automated pipeline that performs conversion and acceleration to be compatible with the framework version, all of the processes described above may be performed in one operation. In this case, the ONNX is an open source format developed for the interoperability of the deep learning model, and is an intermediate format for sharing models between various deep learning frameworks (Tensorflow, Pytorch, Tensor RT). In other words, it is a standard model format that enables the AI model developed in different ML frameworks to be compatible with each other. Alternatively, TensorRT is a model optimization engine that optimizes the AI model to improve an inference speed on NVIDIA GPUs by several to several dozen times. PyTorch is a deep learning framework developed by Facebook to compete with Tensorflow developed by Google.

The generation suppression unit 370 may set a generative adversarial network (GAN)-based noise module (disruption perturbation generator) that generates an evasion attack-based noise template to construct the AI model for suppressing the generation of the deepfake. In this case, the evasion attack is a technique for deceiving machine learning or deep learning models by applying minimal modification to input data. The evasion attack is an attack that causes the machine learning or deep learning models to misclassify using adversarial examples, and is also called an input attack. In this way, by adding a small amount of invisible noise template to a user's photo, even when the deepfake tries to synthesize an image using this photo, the deepfake will generate an abnormal output instead of outputting a normally synthesized photo. This way, even when the user uploads his or her own photo to Instagram, Facebook, or KakaoTalk profile or history, when the user selects the [generation suppression] function and uploads a photo with an added noise template, others will not be able to use the photo to generate deepfake videos or photos, thus achieving the effect of suppressing the generation of the deepfake.

The detection unit 380 may detect low-quality deepfake content by using a multi-scale detection technique using a super-resolution technique, a lifelong learning technique, and a representation learning technique in order to construct the AI model for the deepfake detection. The detection is largely divided into two types: [image] detection and [voice] detection. In the former case, the multi-scale detection technique, the lifelong learning technique, and the representation learning technique may be applied when the image is low-resolution, and in the latter case, a model that identifies voice features may be modeled and used. In this case, the super-resolution technique is a technique that changes the low-resolution image into the high-resolution image to increase the resolution. The multi-scale detection technique is a technique that operates on feature maps of various resolutions to detect objects of various sizes. The lifelong learning technique is a technology that solves the problem of AI forgetting the previously acquired information when training new data, and flexibly handles both previously trained knowledge and new knowledge, and the representation learning technique is a process in which, when only data is provided, core information is extracted from that data and the machine trains the core information on its own. These two learning techniques (lifelong learning+representation learning) are combined and called continuous learning. Continuous learning is a learning method of implementing an artificial intelligence system that may respond to new environmental changes in real time by sequentially training new data when the new data is continuously input.

As a method for detecting low-quality images, BZNet, which applies all of the above-described techniques, may be used. For detailed content on BZNet, refer to the paper (Sangyup Lee, Jaeju An, and Simon S. Woo. 2022. BZNet: Unsupervised Multi-scale Branch Zooming Network for Detecting Low-quality Deepfake Videos. In Proceedings of the ACM Web Conference 2022 (WWW '22). Association for Computing Machinery, New York, NY, USA, 3500?3510. https://doi.org/10.1145/3485447.3512245).

In the case of a voice, a dataset may be generated to construct a model to distinguish and detect the difference between a real voice and a deepfake voice. For this purpose, a voice synthesis model may be used. For example, text to speech (TTS) or voice synthesis (VS) may be used. In addition, overseas deepfake detection challenge datasets such as Korean voice datasets, ASVspoof, Fake_or_Real, and In-the-Wild, which are publicly available on the Internet, may be secured. By constructing a REAL-FAKE dataset and training-validating-testing a voice detection model based on the constructed dataset, modeling can be performed. In order to distinguish between real and fake, a baseline model is selected, and a model with the best detection performance may be selected from among the models that utilize various spectral features of voice and may be set as a model according to an embodiment of the present invention.

In this case, Mel-Spectrogram, constant Q cepstral coefficients (CQCC), rectangular filter cepstral coefficients (RFCC), linear frequency cepstral coefficients (LFCC), [Inverted] Mel frequency cepstral coefficients (MFCC/IMFCC), etc., may be used, but is not limited thereto, to identify and select various spectral features. Therefore, other unlisted techniques may not also be excluded. In addition, the voice detection model may utilize various deep neural network (DNN)-based models. For details, refer to the paper (Lim, D., Jung, S., Kim, E. (2022) JETS: Jointly Training FastSpeech2 and HiFi-GAN for End to End Text to Speech. Proc. Interspeech 2022, 21-25, doi: 10.21437/Interspeech.2022-10294).

The distribution prevention unit 390 collects propagation data including a propagation cycle, a propagation speed, and a propagation form of deepfake content, defines a propagation pattern based on the propagation data, and trains the propagation pattern to predict the propagation of the deepfake content in order to construct the AI model for preventing the distribution of the deepfake. For example, when a deepfake photo of a pornographic type has a propagation pattern of B→C→D→E→F→G, assuming that a user's photo has been converted into pornography and is currently found at location C, the deepfake photo may now be propagated to D, E, F, and G. Therefore, it may be reported in advance to criminal justice authorities so that measures may be taken to prevent the photo from being uploaded. In addition, even when the deepfake photo is uploaded, the damage may be minimized by deleting the deepfake photo before the deepfake photo spreads any further. Also, when the deepfake photo is at location C, it is predicted that the deepfake photo has already been distributed at location B, so the site at location B can also be monitored to quickly remove the user's photo. In the case where the modeling is performed by collecting the propagation cycle, the propagation speed, and the propagation pattern and performing the training-validation-testing, notifying the user of the predicted paths through which his or her photo may spread and reporting the current distribution sources to criminal justice authorities may help expedite the investigation process. To this end, the GNN may be used to identify (for current analysis) how the deepfake photo is propagated, and the GRNN may be used to predict (for future prediction) how the deepfake photo will be propagated. In addition, long-short term memory (LSTM), which is an RNN-based deep learning model, and GNN data are extracted and combined to ultimately predict the propagation process of the deepfake content.

Hereinafter, an example of an operation process according to the configuration of the total solution providing server of FIG. 2 will be described in detail with reference to FIGS. 3a-3b and 4a-4h. However, it will be apparent that the embodiment is only one of various embodiments of the present invention and is not limiting.

Referring to FIG. 3a, in (a) of FIG. 3a, the total solution providing server 300 may construct the MLOps platform to construct and operate the AI model for suppressing generation of, detecting, and preventing distribution of a deepfake. In addition, as in (b) of FIG. 3a, when one function (any one of suppressing generation of, detecting, and preventing distribution of a deepfake) is selected, the function is performed in each container so that the function may be continuously performed even when a failure occurs in any one container. In addition, as in (c) of FIG. 3a, when each AI model for suppressing generation of, detecting, and preventing distribution of a deepfake is constructed through the [ML] of the MLOps, it is now operated through the [Ops]. This is as in (a) to (c) of FIG. 3b. The total solution according to an embodiment of the present invention may be as in FIG. 4Aa. FIGS. 4b and 4c illustrate the infrastructure for constructing the total solution, i.e., the MLOps platform, FIGS. 4d and 4e illustrate a method for shortening an inference time of an AI model through GPU acceleration, FIGS. 4f and 4g illustrate an example of providing services to users based on this platform, and FIG. 4h is a diagram illustrating a deepfake response team formed through public-private cooperation.

Matters not described in the total solution providing method of suppressing generation of, detecting, and preventing distribution of a deepfake of FIG. 2, FIGS. 3a-3b and 4a-4h are identical to or may be easily inferred from the content described for the total solution providing method of suppressing generation of, detecting, and preventing distribution of a deepfake through FIG. 1, so the description thereof will be omitted below.

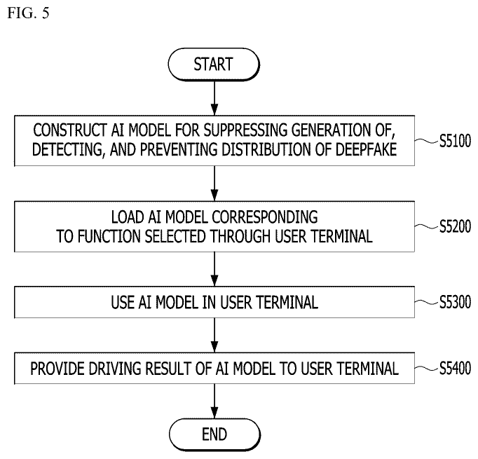

FIG. 5 is a diagram illustrating a process of transmitting and receiving data between the components included in the total solution providing system for suppressing generation of, detecting, and preventing distribution of a deepfake of FIG. 1 according to an embodiment of the present invention. Hereinafter, an example of the process of transmitting/receiving data between the respective components will be described with reference to FIG. 5, but the present application is not limited to such an embodiment, and it is apparent to those skilled in the art that the process for transmitting and receiving data illustrated in FIG. 5 may be changed according to the various embodiments described above.

Referring to FIG. 5, the total solution providing server constructs an AI model for suppressing generation of, detecting, and preventing distribution of a deepfake (S5100), and loads an AI model corresponding to a function selected through the user terminal (S5200).

In addition, the total solution providing server enables the user terminal to use the AI model (S5300), and provides the driving result of the AI model to the user terminal (S5400).

The order between the above-described operations (S5100 to S5400) is merely an example and is not limiting. That is, the order between the above-described operations (S5100 to S5400) may be mutually changed, and some of these operations may be simultaneously executed or deleted.

Matters not described in the total solution providing method of suppressing generation of, detecting, and preventing distribution of a deepfake of FIG. 5 are identical to or may be easily inferred from the content described for the total solution providing method of suppressing generation of, detecting, and preventing distribution of a deepfake through FIGS. 1 to 4, so the description thereof will be omitted below.

The total solution providing method of suppressing generation of, detecting, and preventing distribution of a deepfake according to an embodiment described with reference to FIG. 5 may be implemented in the form of a recording medium including instructions executable by a computer, such as an application or program module executed by a computer. A computer-readable medium may be any available medium that may be accessed by a computer, including both volatile and nonvolatile media and removable and non-removable media. Also, the computer-readable medium may include all computer storage media. The computer storage medium includes both volatile and nonvolatile and removable and non-removable media implemented in any method or technology for storage of information such as computer readable instructions, data structures, program modules, or other data.

The total solution providing method of suppressing generation of, detecting, and preventing distribution of a deepfake according to an embodiment of the present invention described above may be executed by an application installed on the terminal by default (which may include programs included in a platform, an operating system, or the like installed on the terminal by default), and may be executed by an application (i.e., program) installed directly on a master terminal by a user through an application providing server such as an application store server, an application, or a web server related to the corresponding service. In this sense, the total solution providing method of suppressing generation of, detecting, and preventing distribution of a deepfake according to an embodiment of the present invention described above is implemented as an application (i.e., program) installed on a terminal by default or directly installed by a user, and may be recorded on a computer-readable recording medium of the terminal, or the like.

The above description of the present invention is for illustrative purposes, and those skilled in the art to which the present invention pertains will understand that it may be easily modified to other specific forms without changing the technical spirit or essential features of the present invention. Therefore, it should be understood that the above-mentioned embodiments are exemplary in all aspects and are not limiting. For example, each component described as a single type may be implemented in a distributed manner, and similarly, components described as distributed may be implemented in a combined form.

It should be interpreted that the scope of the present invention is defined by the following claims rather than the above-mentioned detailed description and all modifications or alterations deduced from the meaning, scope, and equivalences of the claims are included in the scope of the present invention.

1. A total solution providing system for suppressing generation of, detecting, and preventing distribution of a deepfake, the total solution providing system comprising:
a user terminal that selects any one of functions of suppressing generation of, detecting, and preventing distribution of the deepfake and requests performance of the selected function; and
a total solution providing server including a construction unit that constructs an artificial intelligence (AI) model for suppressing generation of, detecting, and preventing distribution of the deepfake, a loading unit that loads an AI model corresponding to the function selected through the user terminal, a driving unit that allows the user terminal to use the AI model, and a providing unit that provides a driving result of the AI model to the user terminal,
wherein the construction unit constructs the AI model on a machine learning operations (MLOps) platform,
uses, among MLOps tools, Google Vertex AI, Microsoft (MS) machine learning Azure, and Amazon SageMaker as a public cloud, and Kubeflow as an open source code-based project, or constructs and uses MLOps on its own, and
constructs a total solution based on Kubernetes as an open source-based container orchestration tool that allows large-scale deployment, scaling, and management of containerized applications,
the MLOps platform is a platform that constructs a dataset for AI model development and performs preprocessing on the dataset, trains, validates, and tests the preprocessed data using the selected AI model, provides both a development process corresponding to machine learning (ML) that selects and sets a best-performing AI model, and an operation process corresponding to operations (Ops) where a user accesses and operates the actually set AI model, in a single platform, without separately distinguishing between the processes, enabling automatic and continuous retraining as well as deployment and maintenance of a machine learning model in a production environment,
the Google Vertex AI is a platform that uses a Google Cloud Platform (GCP)-based Vertex AI platform as its driving platform, and a platform that supports a data labeling service and dataset management during data preparation, executes an integrated metadata-based pipeline and supports parallel processing during training and parallel processing of a neural network model, deploys the neural network model based on a custom, supports traffic distribution and low latency, and allows latency monitoring,
the MS machine learning Azure is a platform that uses an Azure-based MLOps platform as its driving platform, supports a data labeling service during data preparation, performs pipeline-based learning for parallel processing, deploys the neural network models based on the custom, processes a graphics processing unit (GPU) and the traffic distribution, performs delay and hardware (HW) resource monitoring, and supports workspace management,
the Amazon SageMaker is a platform that uses an AWS-based MLOps platform as its driving platform, supports ground truth for data labeling during the data preparation, supports a pipeline, deploys the neural network model based on the custom, supports the traffic distribution, a multi-model, and elastic inference for the low latency, supports a custom monitoring schedule, and supports neural network management by version, group, and institution,
the Kubeflow is a driving platform based on a Kubernetes-based open source, and is a platform that uses a Jupyter notebook during the data preparation, supports pipeline and hyperparameter tuning, supports pre/post-processing inference phases when deploying the neural network model, supports automatic scaling, the traffic distribution, a multi-model service, and a GPU integrated execution function, and supports resources and a high-level matrix,
the loading unit loads the AI model according to the selection of the deepfake generation suppression when the user selects the deepfake generation suppression because he or she wants to prevent a photo he or she uploads to an SNS from being generated as the deepfake,
additionally loads the AI model corresponding to the selection of the deepfake detection when the user selects the deepfake detection because he or she is curious about whether his or her face is being synthesized as the deepfake and spread on the user terminal, and
loads the AI model corresponding to the selection of the deepfake distribution prevention when the user selects the deepfake distribution prevention on the user terminal to predict how far his or her photo spreads and to prevent further spread of his or her photo after identifying that his or her photo is spreading,
the driving unit allows the user to prevent his or her photo from being synthesized into the deepfake and distributed by using the selected function, to identify whether his or her photo is synthesized into the deepfake and distributed, and the photo synthesized into the deepfake has started spreading, identifies where the photo is likely to spread in the future and takes measures to prevent further spread of the photo,
considering that distribution, possession, purchase, storage, or viewing of deepfake sexual crime materials results in imprisonment or fines, when the function of the AI model selected through the user terminal detects the deepfake, the photo synthesized into the deepfake is actually detected, and the photo detected on the user terminal is confirmed as the deepfake photo, the providing unit adds a watermark to the detected photo to prevent viewing of the detected photo, and guides others to identify that the detected photo is the deepfake photo and prevent distribution or downloading of the deepfake photo, and
even without confirmation from the victim himself or herself, independently performs the watermark processing on the photo that is actually discriminated to be deepfake content, and
the total solution providing server is composed of a node corresponding to a physical server and at least one GPU connected to the node, the node being generated as a cluster that is connected to a network and performs a function, and at least one GPU being connected to one node,
increases the number of nodes and GPUs according to a demand of the AI model, the increase in the number of nodes and GPUs actually meaning connecting additional hardware, or when the hardware is already configured, meaning allocating the already configured hardware through software to fill a computing resource amount required by the AI model,
applies a container technology, a cluster technology, and an orchestration technology for servicing the ML and the Ops in the MLOps,
when the user terminal requests a desired ML service from the MLOps platform, allows the edge cloud to perform the ML operation requested by the user and then provide the result to the user, requests an operation of the model in which the ML service does not exist in the edge cloud, when a pre-trained model is outdated and thus the model needs to be updated, transmits data to the core cloud, requests a newly trained model, allows a core cloud to train the model and deploy the trained model to each edge cloud, and allows the user to receive the result of the ML service requested through an MLOps framework using the model deployed on the edge cloud,
manages the ML service as a container in the allocated edge cloud,
when the user requests an image classification model, allows the edge cloud to generate the container for performing image classification and to perform an inference process, while, when no pre-trained model exists in a model repository, performs a training phase of the image classification model, and in the training phase, trains the image classification model using the data collected and stored within the model training container in the core cloud, and deploys the trained image classification model to the edge cloud,
during container-based deployment, ensures that one installed operating system (OS) is used regardless of a computer type in case of an OS, and resources are allocated and managed for each program in the OS in case of the resources, isolated in a program execution environment, and shared in case of an OS environment,
uses the Kubernetes to distribute and arrange the containers across the nodes, replace problematic containers, or manage passwords and settings to be used for the containers,
performs construction and evaluation of a standard dataset for validating a deepfake detection model to construct a total solution, performs evaluation of robustness and generalization performance of the deepfake detection model, performs deepfake composite dataset augmentation to validate the robustness of the deepfake detection model, and validates the augmented dataset and deploys the validated data,
performs definition and structuring of an initial propagation pattern of the deepfake content in relation to structuring of propagation characteristics of the deepfake content, and generates and deploys a deepfake content propagation tree model,
collects a deepfake voice and develops a deepfake voice detection model, but generates a partially tampered deepfake voice dataset to enhance deepfake voice detection in a real environment, and generates and deploys a partially tampered deepfake voice detection model,
sets up an operating environment for a multimodal detection model, a propagation path prediction model, and a generation suppression model for a construction of an anti-deepfake total solution environment and GPU acceleration, converts the framework into open neural network exchange (ONNX) and applies TensorRT to shorten a model inference time in relation to the development of an AI model GPU acceleration pipeline, APlizes models with Flask in relation to a construction of a distributed processing system for real-time media upload, manages an API call and a media transmission/reception load, and performs resource allocation of a fluid backend system, and
performs development and testing on a demo system prototype, performs tests on media transmission time and model driving during testing, and performs an operation on a living lab for activating deepfake crime prevention.

2. The total solution providing system of claim 1,
wherein the total solution providing server further includes a parallel execution unit that is configured, when performing a function of suppressing generation of, detecting, and preventing distribution of the deepfake, so that a cluster executes the function with a plurality of containers, and operates so that even when a failure occurs in any one of the plurality of containers, another container performs the function in its place.

3. The total solution providing system of claim 1,
wherein the total solution providing server further includes a performance enhancement unit that applies acceleration and lightweight technology of the AI model in order to enhance training and inference performance of the AI model.

4. The total solution providing system of claim 1,
wherein the total solution providing server further includes a generation suppression unit that sets up a generative adversarial network (GAN)-based noise module (disruption perturbation generator) generating an evasion attack-based noise template in order to construct the AI model for suppressing the generation of the deepfake.

5. The total solution providing system of claim 1,
wherein the total solution providing server further includes a detection unit that detects low-quality deepfake content by using a multi-scale detection technique using a super-resolution technique, a lifelong learning technique, and a representation learning technique to construct the AI model for detecting the deepfake.

6. The total solution providing system of claim 1,
wherein the total solution providing server further includes a distribution prevention unit that collects propagation data including a propagation cycle, a propagation speed, and a propagation form of deepfake content, defines a propagation pattern based on the propagation data, and trains the propagation pattern to predict the spread of the deepfake content.
